(19) United States
(12) Patent Application Publication
(10) Pub. No.: US 2017/0045011 A1
(43) Pub. Date: Feb. 16, 2017

(54) FUZZY CONTROL OF AN INTERNAL COMBUSTION ENGINE

(71) Applicant: Robert Bosch GmbH, Stuttgart (DE)

(72) Inventor: Michael Fey, Wiernsheim (DE)

(21) Appl. No.: 15/232,933

(22) Filed: Aug. 10, 2016

(30) Foreign Application Priority Data
Aug. 12, 2015 (DE) 102015215343.6

(51) Int. Cl. F02D 41/26; B01D 53/94; F01N 9/00

(52) U.S. Cl. CPC F02D 41/26; F01N 9/007; B01D 53/9495; B01D 53/9445; F01N 2560/025; F02D 2200/0814

(57) ABSTRACT

To further reduce pollutant emissions during operation of an internal combustion using an exhaust catalytic converter and in particular to promptly detect and possibly even prevent a departure from the catalytic converter window, a first oxygen filling level in a front area of the exhaust catalytic converter and a second oxygen filling level in a rear area be determined as a function of a signal of a lambda sensor and that the fuel mixture of the internal combustion engine be influenced as a function of the two oxygen filling levels with the aid of a fuzzy controller.

### CROSS REFERENCE

The present application claims the benefit under 35 U.S.C. §119 of German Patent Application No. DE 102015215343.6 filed on Aug. 12, 2015, which is expressly incorporated herein by reference in its entirety.

### FIELD

The present invention relates to a method for controlling the operation of an internal combustion engine, an exhaust aftertreatment system being assigned to the internal combustion engine, which includes at least one exhaust catalytic converter and one lambda sensor situated upstream from the exhaust catalytic converter.

### BACKGROUND INFORMATION

The present invention also relates to a control unit for controlling the operation of an internal combustion engine and a computer program, which is stored in a control unit for controlling and/or regulating the operation of an internal combustion engine.

In an incomplete combustion of an air-fuel mixture in an internal combustion engine, for example, a gasoline engine, additional combustion products, such as hydrocarbons (HC), carbon monoxide (CO) and nitrogen oxides (NOx), the amounts of which are limited by law, are emitted in addition to nitrogen (N₂), carbon dioxide (CO₂) and water (H₂O). According to the present state of the art, it is possible to comply with the exhaust limiting values which are in effect for motor vehicles only with a catalytic exhaust aftertreatment. For example, all the pollutants mentioned above, whose emissions are limited by law, may be converted by using a three-way catalytic converter.

A comparably high conversion rate for HC, CO and NO is achieved in particular with three-way catalytic converters only in a narrow lambda range around the stoichiometric operating point (lambda=1), the so-called “catalytic converter window.” For operation of the catalytic converter in the catalytic converter window, a lambda control based on the signals of lambda sensors upstream and downstream from the catalytic converter is typically used in contemporary engine control systems and control units. For lambda control, the oxygen content of the exhaust upstream from the catalytic converter is measured using the lambda sensor situated there. The amount of fuel determined by a pilot control is corrected as a function of the measured value thereby detected. A more accurate control of the amount of fuel is possible if the exhaust downstream from the catalytic converter is additionally analyzed with another lambda sensor. The signal of the lambda sensor situated downstream from the catalytic converter is used for a setpoint control, for example, which is superimposed on the lambda control upstream from the catalytic converter. A two-point lambda sensor is often used as the lambda sensor downstream from the catalytic converter, which may have a very steep characteristic line at lambda=1 and is therefore able to display lambda=1 with very high accuracy.

In addition to the setpoint control, which usually compensates for only minor deviations from lambda=1 and works comparatively slowly, there is at least one functionality in contemporary engine control systems which ensures after major deviations from lambda=1 in the form of a lambda pilot control that the catalytic converter window will be reached again quickly, for example, after phases having overrun fuel cutoff (so-called catalytic converter clearing).

However, the conventional control concepts have the disadvantage that they recognize a departure from the catalytic converter window on the basis of the voltage of the two-point lambda sensor downstream from the catalytic converter only at a relatively late point in time.

Another possibility for controlling the amount of fuel or the air-fuel mixture, with the aid of the signal of a lambda sensor downstream from the catalytic converter, is based on control of the average oxygen filling level in the catalytic converter. However, since this average filling level is not measurable, it may only be modelled. However, it is usually very complicated and expensive to create the models required for this purpose. For example, a three-way catalytic converter involves a complex nonlinear segment having time-variant segment parameters. Therefore, engine control units do not usually include generally valid segment models capable of describing the behavior of the catalytic converter with regard to a traditional filling level control in different operating states, for example, taking into account different engine operating points and aging of the catalytic converter.

In addition, the average oxygen filling level in the catalytic converter corresponds to the exhaust composition at the outlet of the catalytic converter only to a limited extent, so that a control based on this cannot ensure the desired accuracy.

### SUMMARY

An object of the present invention is to make available an improved control of the internal combustion engine in comparison with the conventional methods with regard to the resulting emissions, so that a departure from the catalytic converter window is detectable at an early point in time in particular, so that this departure is preventable or a return to the catalytic converter window is accelerated.

The present invention is achieved by a method of the type mentioned at the outset, in that a first oxygen filling level in a front area and a second oxygen filling level in a rear area of the exhaust catalytic converter are determined as a function of a signal of the lambda sensor upstream from the exhaust catalytic converter, and the fuel mixture of the internal combustion engine is influenced by a fuzzy controller as a function of the two oxygen filling levels, the oxygen filling levels being ascertained with the aid of a model of the exhaust catalytic converter according to one advantageous specific embodiment.

Consequently, according to the present invention, a fuzzy controller is provided in combination with a simplified catalytic converter model. The oxygen filling level of the catalytic converter is modeled for two zones within the catalytic converter on the basis of the signal of the lambda sensor upstream from the catalytic converter. The provided method is based on the finding that the filling level in a comparatively small area at the output of the catalytic converter is crucial for the instantaneous exhaust composition downstream from the catalytic converter, whereas the oxygen filling level in the volume situated in front and its development are crucial for the development of the oxygen filling level in this small area at the output of the catalytic converter. Furthermore, it has been found that, although the catalytic converter window corresponds to a relatively sharp and narrow lambda range, it also corresponds to a comparatively broad and fuzzy oxygen filling level range because of the storing property of the catalytic converter.

The provided control method thus covers both the functions of the setpoint control described at the outset and the tasks of the “catalytic converter clearing” function, as well as comparable functionalities. In addition, the method according to the present invention has the advantage that an imminent departure from the catalytic converter window is detectable at an earlier point in time than is the case with existing control concepts, so that this may be counteracted by a prompt and targeted correction of the air-fuel mixture before actually departing from the catalytic converter window. This means a reduction in pollutant emissions, so that stricter statutory requirements than those in effect at the present may also be met with relatively low costs with the aid of pre-existing catalytic converters.

According to a preferred specific embodiment, a first deviation of the first oxygen filling level from a first setpoint filling level and a first gradient of the first deviation are determined. Furthermore, a second deviation of the second oxygen filling level from the second setpoint filling level and the second gradient of the second deviation are determined. Depending on the first and second deviations as well as the first and second gradients, the fuel mixture of the internal combustion engine is influenced by the fuzzy controller.

Consequently, the deviation from a setpoint filling level and the gradient of the deviation from the setpoint filling level are calculated from the oxygen filling levels thus ascertained. On the basis of these four variables, it is possible to infer how the air-fuel mixture must be corrected in order not to depart from the catalytic converter window or how to reach it again quickly. According to one possible specific embodiment, these four variables are used as input variables for the fuzzy controller, which is able to generate a corresponding control action with the aid of a comparatively small set of easily comprehensible rules. For example, a model of the catalytic converter, which calculates the oxygen filling level in the two ranges of the catalytic converter on the basis of the signal of the lambda sensor upstream from the catalytic converter, is implemented in the control unit software. With the aid of this model, a first oxygen filling level is then calculated in a front zone facing the input of the catalytic converter, and a second oxygen filling level is calculated in a rear zone facing the output of the catalytic converter. The front zone is preferably larger than the rear zone.

According to a preferred specific embodiment, the model of the exhaust catalytic converter is calibrated with the aid of a sensor downstream from the exhaust catalytic converter. For example, a two-point lambda sensor may be used, which is situated downstream from the catalytic converter and indicates unambiguously when the catalytic converter is completely filled with oxygen or completely emptied of oxygen. This may be used to bring the modeled oxygen filling level into agreement with the actual oxygen filling level after lean or rich phases and to adapt or calibrate the model of the exhaust catalytic converter, if necessary. The reliability of the model of the exhaust catalytic converter may be further increased in this way.

According to another advantageous specific embodiment, the first and the second oxygen filling levels are standardized with respect to an instantaneous oxygen storage capacity of the exhaust catalytic converter. Thus, the accuracy of the control may be further improved. The reference to a setpoint filling level and the standardization to the instantaneous oxygen storage capacity of the exhaust catalytic converter have the advantage that the fuzzy sets may be formulated independently of the setpoint filling level and of the instantaneous oxygen storage capacity of the catalytic converter.

In one possible specific embodiment, in which the oxygen filling levels and their gradients are used as input variables, a membership function of the fuzzy controller for the first and/or second oxygen filling level(s) includes at least three subsets, where
a first subset has a maximum value in a range from 0% to approximately 10% and a ramp descending to a value of 0 in the range from approximately 10% to approximately 20%;
a second subset has a ramp ascending from 0 to a maximum value in a range of approximately 10% to approximately 20%, has a maximum value in a range from approximately 20% to approximately 80% and a ramp descending to a value of zero from 80% to approximately 90%, and
a third subset has a ramp ascending from the value 0 to a maximum value in the range from approximately 80% to approximately 90% and a maximum value in the range from 90% to 100%.

According to another possible specific embodiment, a membership function of the fuzzy controller includes at least three subsets for the first and/or second gradients, where
a first subset has a maximum value in a range down to approximately −2% per second and a ramp descending to a value of zero in a range from approximately −2% per second to approximately 0% per second;
a second subset has a ramp ascending from 0 up to a maximum value in a range from approximately −2% per second to approximately 0% per second and a ramp descending down to a value of zero in the range from approximately 0% per second to approximately 2% per second; and
a third subset has a ramp ascending from the value 0 up to a maximum value in a range from approximately 0% per second to approximately 2% per second and a maximum value beyond 2% per second.

These membership functions are to be understood as possible examples and are suitable for effectively influencing the control of the air-fuel mixture with a preferably small set of fuzzy rules in order to promptly detect or prevent a departure from the catalytic converter window.

The object may also be achieved by a control unit for regulating the operation of an internal combustion engine by the fact that a fuzzy controller is included in the control unit via the method according to the present invention. This object is also achieved by a computer program, which is stored in a control unit for controlling and/or regulating the operation of an internal combustion engine by the fact that the method according to the present invention is carried out when the computer program is executed on the control unit.

Additional features, possible applications and advantages of the present invention are derived from the description below of exemplary embodiments, which are explained with reference to the figures; the features may be important for the present invention either alone or in various combinations without explicitly making reference thereto.

### BRIEF DESCRIPTION OF THE DRAWINGS

FIG. 1 shows a schematic representation of an internal combustion engine including an exhaust aftertreatment system.

FIG. 2 shows a flow chart including method steps of a possible specific embodiment of the method according to the present invention.

FIG. 3 shows a schematic block diagram of a lambda control structure including a fuzzy controller.

FIG. 4 shows a graphic representation of an example of membership functions for four possible input variables of the fuzzy controller.

### DETAILED DESCRIPTION OF EXAMPLE EMBODIMENTS

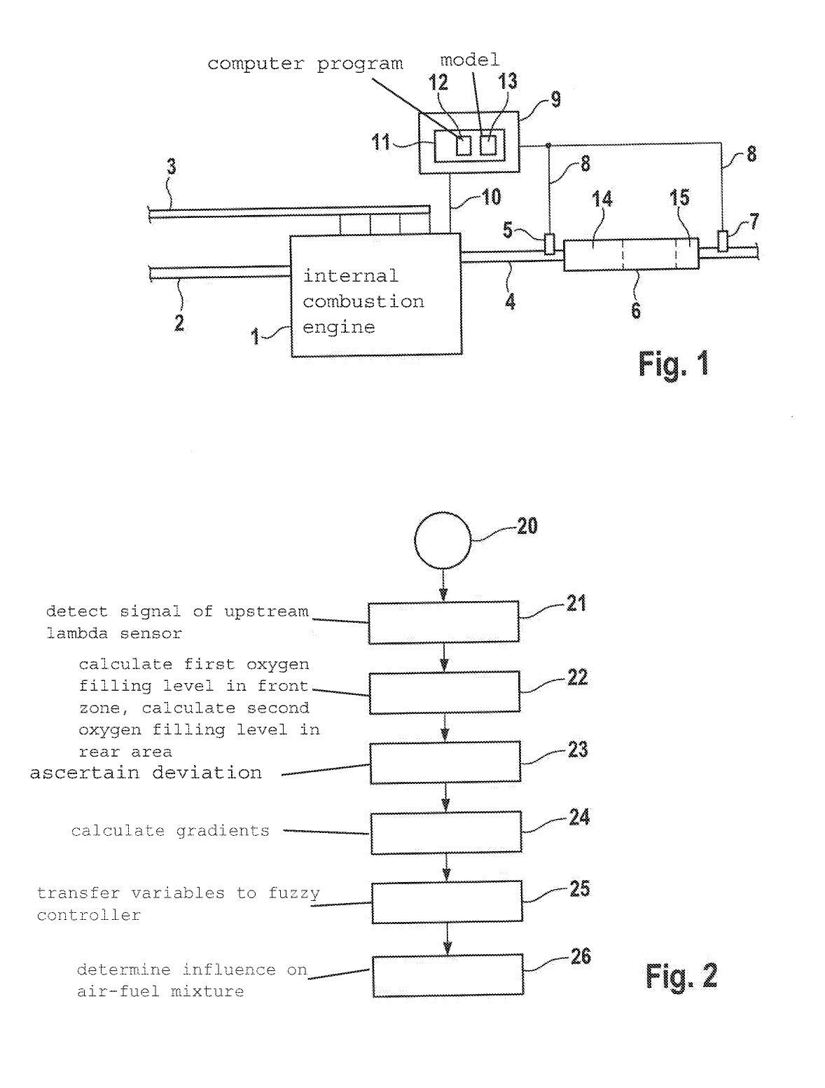

FIG. 1 shows an internal combustion engine 1, which includes an intake tract 2, a fuel supply line 3 and an exhaust tract 4. A lambda sensor 5 is situated in exhaust gas tract 4 upstream from a catalytic converter 6, which is designed as a three-way catalytic converter, for example, and a lambda sensor 7 is situated downstream from catalytic converter 6. Lambda sensors 5 and 7 are connected to a control unit 9 via signal lines 8.

Control unit 9 is connected to internal combustion engine 1 via signal lines and/or a bus system 10.

A memory area 11, in which a computer program 12 and a model 13 of catalytic converter 6 are stored, is located in control unit 9, which is configured for controlling and/or regulating the operation of internal combustion engine 1.

In the catalytic converter, a front area 14 and a rear area 15 are shown, representing the zones, in which the first oxygen filling level and the second oxygen filling level are ascertained.

FIG. 2 shows a flow chart, illustrating a few method steps of one possible specific embodiment of the present invention. This method begins in a step 20, for example, on starting of internal combustion engine 1. In a step 21, the signal of lambda sensor 5 upstream from exhaust catalytic converter 6 is detected. In step 22, a first oxygen filling level in a front zone or area facing the input of catalytic converter 6 is calculated, and a second oxygen filling level in a rear area facing the output of catalytic converter 6 is calculated using a model 13 of catalytic converter 6, which may have a comparatively simple structure. The front area is preferably larger than the rear area.

In a step 23, the deviations in the oxygen filling levels ascertained in step 22 from predefined setpoint filling levels are determined. In a step 24, a first gradient of the first deviation from the first setpoint filling level and a second gradient of the second deviation from the second setpoint filling level are calculated, whereby the first and second setpoint filling levels possibly may be different of course.

In a step 25, the variables ascertained in steps 23 and 24 as input variables are transferred to fuzzy controller 13. The input variables are put in relation to the membership functions defined in fuzzy controller 13, and then in a step 26, a decision is made on the basis of previously defined fuzzy rules as to whether and, if so, how the air-fuel mixture is influenced by generating a corresponding control intervention to promptly detect and prevent a departure from the catalytic converter window or to preferably return rapidly back to the catalytic converter window.

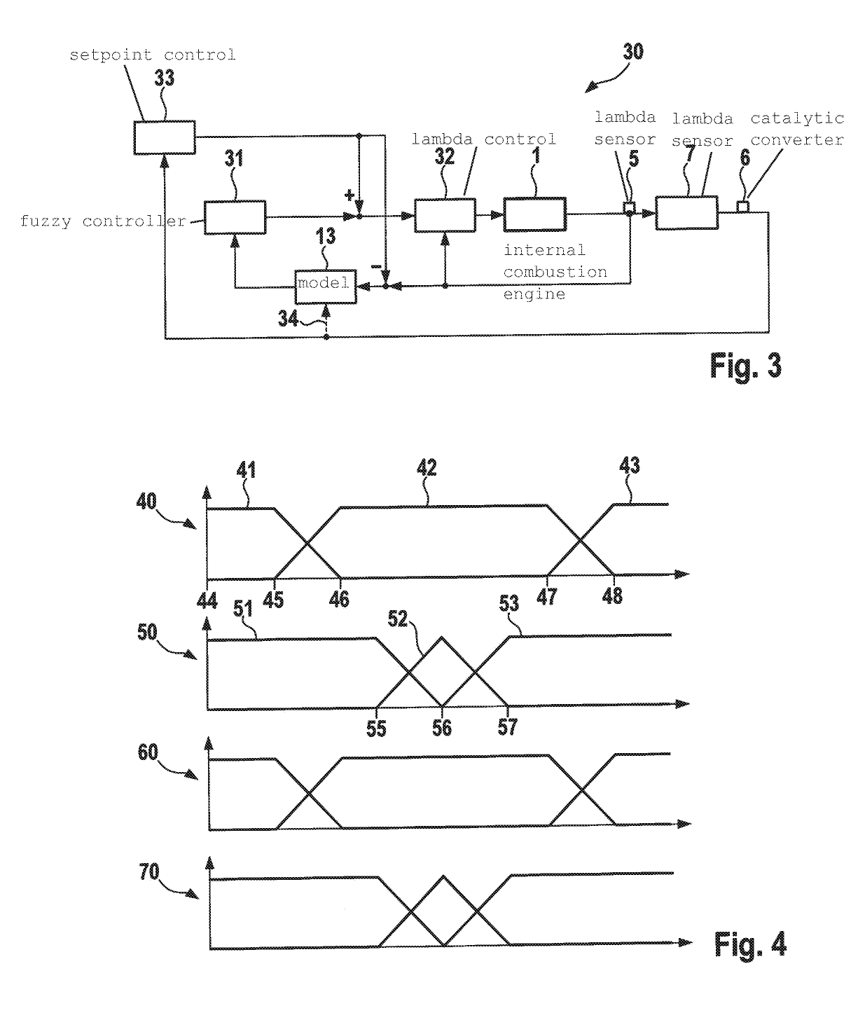

FIG. 3 shows a lambda control structure 30, which is suitable for a lambda control of an internal combustion engine 1 and in which a fuzzy controller 31 is embedded. Block diagram 3 shows that, on the basis of the signal of lambda sensor 5, which is situated upstream from catalytic converter 6, the input variables for fuzzy controller 31 are formed in a model 13 of exhaust catalytic converter 6. In addition, the signal of lambda sensor 5 is also used for the “normal” lambda control, which is represented in a block 32.

Depending on the result of the fuzzy control, fuzzy controller 31 generates a signal, which represents a correction of the lambda setpoint value and influences lambda control 32.

The diagram in FIG. 3 also shows that the signal of lambda sensor 7, which is situated downstream from catalytic converter 6, is used for setpoint control in a block 33, in which a correction of an offset value for lambda sensor 5 is generated and made available to the lambda control in block 32.

Furthermore, the signal of lambda sensor 7 is used for a calibration, which is indicated by the dashed arrow 34. For example, lambda sensor 7, which is designed as a two-point lambda sensor downstream from catalytic converter 6, indicates when catalytic converter 6 is filled completely with oxygen or is emptied completely of oxygen. This is then used to bring the modeled oxygen filling level into agreement with the actual oxygen filling level after lean phases or rich phases and to adapt the catalytic converter model, if necessary.

The setpoint control based on the signal of lambda sensor 5, downstream from three-way catalytic converter 6, assumes only the detection and correction of an offset of lambda sensor 5 upstream from the catalytic converter in the exemplary embodiment shown in FIG. 3. Model-based fuzzy controller 31 ensures operation of catalytic converter 6 in the catalytic converter window of optimal emissions.

FIG. 4 shows four sub-diagrams 40, 50, 60 and 70. Sub-diagram 40 is a graphical representation of a possible membership function for the setpoint filling level of the front area of the catalytic converter, including a first subset 41, a second subset 42 and a third subset 43. First subset 41 has a maximum value in a range from 44 to 45, which corresponds to 0% to approximately 10%, for example, and a ramp descending to the value 0 in a range from 45 to 46, which corresponds to 10% to approximately 20%, for example. Second subset 42 has an ascending ramp in the range from 45 to 46 (for example, 10% to 20%), a maximum value in the range from 46 to 47 (for example, 20% to 80%) and in a range from 47 to 48 (for example, 80% to 90%), it has a ramp descending to the value 0. Third subset 43 has a ramp ascending in a range from 47 to 48 (for example, 80% to 90%) and a maximum value beyond the value 48 (for example, 90%).

Sub-diagram 50 represents by way of example a membership function for the gradient of the first oxygen filling level of the front area in catalytic converter 6 and includes three subsets 51, 52 and 53. First subset 51 corresponds to a decreasing gradient and has a maximum value in a range from 54 to 55 (for example, −2% per second) and a ramp descending to the value 0 in a range from 55 to 56 (for example, 0% per second). Second subset 52 includes an ascending ramp and a descending ramp and has its maximum value at location 56 corresponding to 0% per second, for example. Third subset 53 corresponds to an increasing gradient and has an ascending ramp in the range from 56 to 57 (for example, 0% to +2% per second) and a maximum value beyond the value 57 (for example, +2% per second).

Sub-diagram 60 corresponds to sub-diagram 40 in the example shown in FIG. 4, where sub-diagram 60 shows the membership function for the oxygen filling level of the rear area of catalytic converter 6. Similarly, sub-diagram 70 corresponds to sub-diagram 50, sub-diagram 70 showing a possible membership function of the gradient of the second oxygen filling level of the rear area of the catalytic converter.

Based on the membership functions shown in FIG. 4, a preferably small set of fuzzy rules may be defined, for example, as follows:
IF the front filling level is high AND the front filling level is ascending AND the rear filling level is high AND the rear filling level is ascending, THEN make the air-fuel mixture much richer.
IF the front filling level is high AND the front filling level is descending AND the rear filling level is low AND the rear filling level is ascending, THEN do not change the air-fuel mixture.

Rules may be defined for the other possible combinations accordingly.

FIG. 4 also takes into account in particular a possible use of the fuzzy controller in an engine control unit having limited resources since membership functions 40, 50, 60 and 70 of the four input variable are defined by using preferably few fuzzy sets, but that does not result in any significant restrictions on the quality of the provided method.

What is claimed is:

1. A method for controlling operation of an internal combustion engine, an exhaust aftertreatment system being assigned to the internal combustion engine, including at least one exhaust catalytic converter and one lambda sensor situated upstream from the exhaust catalytic converter, the method comprising:
determining, as a function of a signal of the lambda sensor, a first oxygen filling level in a front area of the exhaust catalytic converter, and a second oxygen filling level in a rear area of the exhaust catalytic converter; and
influencing, with the aid of a fuzzy controller, a fuel mixture of the internal combustion engine as a function of the first oxygen filling level and the second oxygen filling level.

2. The method as recited in claim 1, wherein the first oxygen filling level and the second oxygen filling level are determined with the aid of a model of the exhaust catalytic converter.

3. The method as recited in claim 1, wherein a first deviation of the first oxygen filling level from a first setpoint filling level and a first gradient of the first deviation are determined, a second deviation of the second oxygen filling level from a second setpoint filling level and a second gradient of a second deviation are determined, and the fuel mixture of the internal combustion engine is influenced as a function of the first and second deviations and of the first and second gradients with the aid of the fuzzy controller.

4. The method as recited in claim 1, wherein the front area is larger than the rear area.

5. The method as recited in claim 4, wherein the model of the exhaust catalytic converter is calibrated with the aid of a sensor situated downstream from the exhaust catalytic converter.

6. The method as recited in claim 1, wherein the first and second oxygen filling levels are standardized with respect to an instantaneous oxygen storage capacity of the exhaust catalytic converter.

7. The method as recited in claim 3, wherein a membership function of the fuzzy controller for at least one of the first oxygen filling level and the second oxygen filling level includes at least three subsets, wherein:
a first subset has a maximum value in a range from 0% to approximately 10% and a ramp descending to a value of zero in the range from approximately 10% to approximately 20%;
a second subset has a ramp ascending from 0 to a maximum value in a range from approximately 10% to approximately 20%, a maximum value in a range from approximately 20% to approximately 80% and a ramp descending to a value of zero in a range from approximately 80% to approximately 90%; and
a third subset has a ramp ascending from a value of zero up to a maximum value in a range from approximately 80% to approximately 90% and a maximum value beyond approximately 90%.

8. The method as recited in claim 3, wherein a membership function of the fuzzy controller for at least one of the first gradient and the second gradient includes at least three subsets, wherein:
a first subset has a maximum value in a range down to approximately −2% per second and a ramp descending to a value of zero in a range from approximately −2% per second to approximately 0% per second;
a second subset has a ramp ascending from 0 to a maximum value in a range from approximately −2% per second to approximately 0% per second and a ramp descending to the value of zero from approximately 0% per second to approximately 2% per second; and
a third subset has a ramp ascending from a value of zero to a maximum value in a range from approximately 0% per second to approximately 2% per second and a maximum value beyond 2% per second.

9. A control unit for regulating the operation of an internal combustion engine, an exhaust aftertreatment system being assigned to the internal combustion engine, including at least one exhaust catalytic converter and one lambda sensor situated upstream from the exhaust catalytic converter, the control unit configured to:
determine, as a function of a signal of the lambda sensor, a first oxygen filling level in a front area of the exhaust catalytic converter, and a second oxygen filling level in a rear area of the exhaust catalytic converter; and
influence, with the aid of a fuzzy controller, a fuel mixture of the internal combustion engine as a function of the first oxygen filling level and the second oxygen filling level;
wherein the fuzzy controller is formed in the control unit.

10. A non-transitory computer-readable storage medium storing a computer program for controlling operation of an internal combustion engine, an exhaust aftertreatment system being assigned to the internal combustion engine, including at least one exhaust catalytic converter and one lambda sensor situated upstream from the exhaust catalytic converter, the computer program, when executed by a control unit, causing the control unit to perform:
determining, as a function of a signal of the lambda sensor, a first oxygen filling level in a front area of the exhaust catalytic converter, and a second oxygen filling level in a rear area of the exhaust catalytic converter; and
influencing, with the aid of a fuzzy controller, a fuel mixture of the internal combustion engine as a function of the first oxygen filling level and the second oxygen filling level.
